(19) United States
(12) Patent Application Publication
(10) Pub. No.: US 2002/0096548 A1
(43) Pub. Date: Jul. 25, 2002

(54) Washer supply device on a power nailer

(76) Inventor: Chen-Fa Huang, Ta Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/765,565

(22) Filed: Jan. 22, 2001

(51) Int. Cl. B25C 7/00

(52) U.S. Cl. 227/15

(57) ABSTRACT

A washer supply device includes a hollow tubular member connected to a side of a power nailer and an opening is defined longitudinally through the tubular member. A washer transferring member is connected to the power nailer a hole is defined through the washer transferring member. A plurality of washers each have a central hole and a flexible wire frictionally extends through the central holes to collect the washers together so that the washers are received in the tubular member via the opening. The wire is pulled out from the washers via the hole in the washer transferring member.

### FIELD OF THE INVENTION

The present invention relates to a washer supply device includes a tubular member on a side of a power nailer. The washers each have a hole and a flexible wire extends through the holes of the washers and insert the washer in the tubular member. The wire is pulled from the washers after the washers are received in the tubular member.

### BACKGROUND OF THE INVENTION

A conventional washer supply device for a power nailer 12 is shown in FIGS. 1 and 2 and generally includes a retaining tube 13 connected to a side of the power nailer 12 and a pushing rod 150 extends through the retaining tube 13. A spring 15 is connected to the pushing rod 150 and a pushing end 151 is connected to a lower end of the pushing rod 150. A washer transferring member 14 connected to a nose 120 of the nailer 12 and a tubular casing 11 is engaged between the retaining tube 13 and the washer transferring member 14. A plurality of washers 10 are piled in the tubular casing 11 and the washers 10 can be transferred to the nose 120 so as to be work with the nails ejected from the nose 120. The washers 10 are pressed downward by the pushing end 151 and the tubular casing 11 is made of stiff material so that when some of the washers 10 are jammed in the tubular casing 11, the tubular casing 11 has to be discarded. The tubular casing 11 cannot be reused again so that it is a huge waste and the cost for the tubular casings 11 are expensive.

The present invention intends to provide a washer supply device wherein the washers are connected by a flexible wire and no tubular casing is waated.

### SUMMARY OF THE INVENTION

In accordance with one aspect of the present invention, there is provided a washer supply device and comprises a hollow tubular member connected to a side of a power nailer and an opening is defined longitudinally through the tubular member. A washer transferring member is connected to the power nailer and a lower end of the tubular member is rested on the washer transferring member. A hole is defined through the washer transferring member and communicates with an interior of the tubular member. A cap is connected to a top end of the tubular member and a pushing rod extends through the cap and a pushing end is connected to a lower end of the pushing rod. A spring is mounted to the pushing rod and located between the cap and the pushing end. A plurality of washers each have a central hole and a flexible wire frictionally extends through the central holes. The washers are received in the tubular member via the opening and the wire is pulled out from the washers via the hole in the washer transferring member.

The primary object of the present invention is to provide a washer supply device wherein the washers are collected by a wire and no tubular casings are required.

These and further objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is an exploded view to show a conventional washer supply device for power nailers;

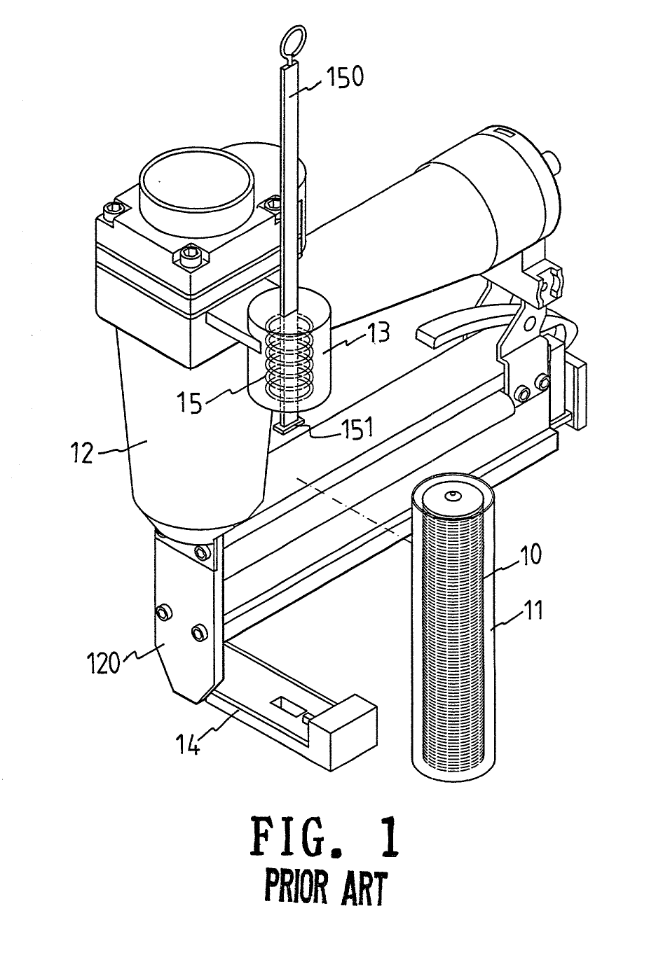

FIG. 2 is a cross sectional view to show the conventional washer supply device;

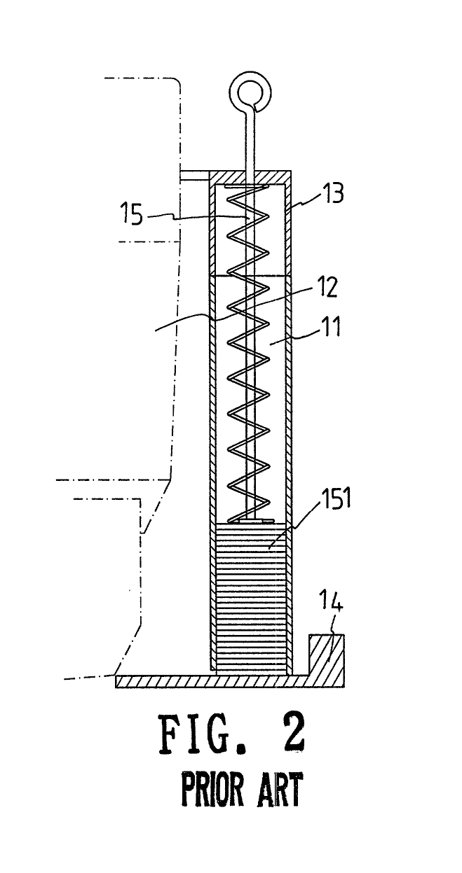

FIG. 3 is an exploded view to show a washer supply device of the present invention;

FIG. 4 is a cross sectional view to show the washer supply device of the present invention;

FIG. 5 is a perspective view to show the washer supply device of the present invention, and

FIG. 6 is an exploded view to show another embodiment of the wire extending through washers.

### DETAILED DESCRIPTION OF THE PREFERRED EMBODIMENT

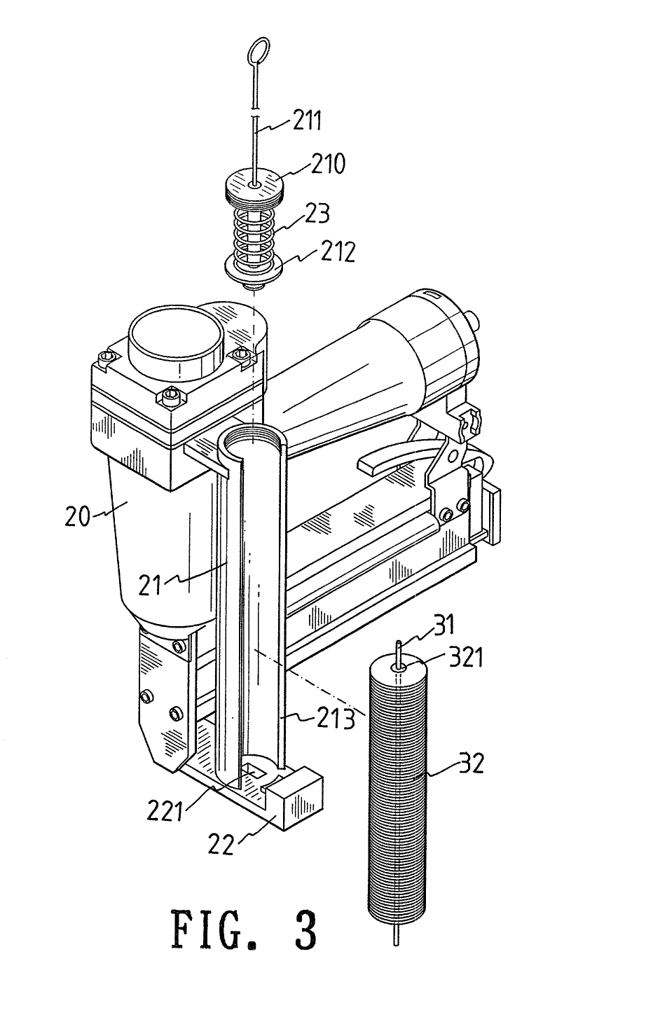

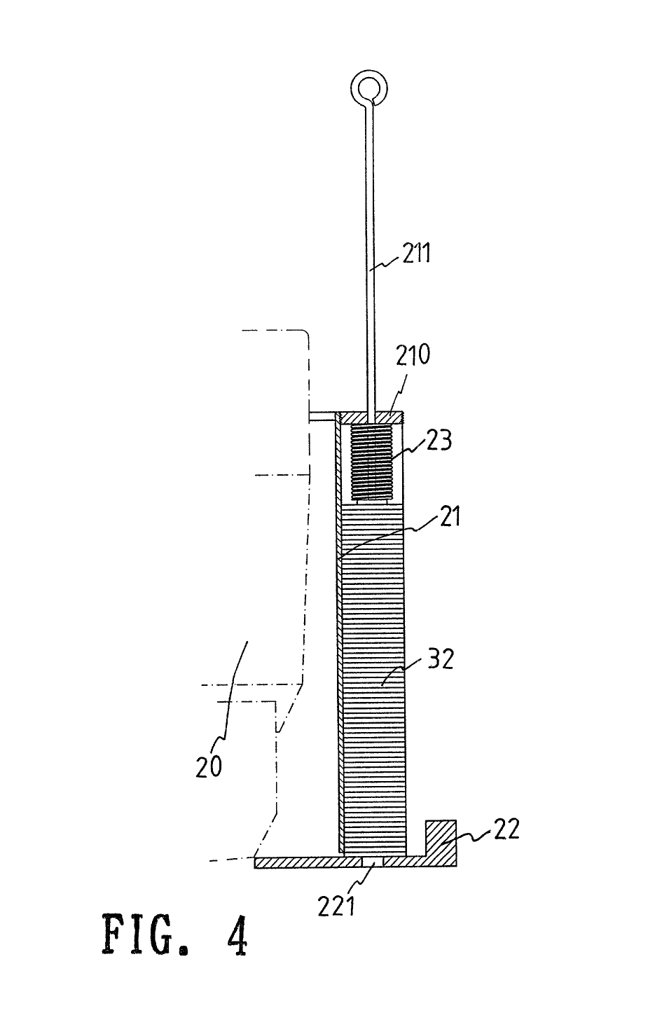

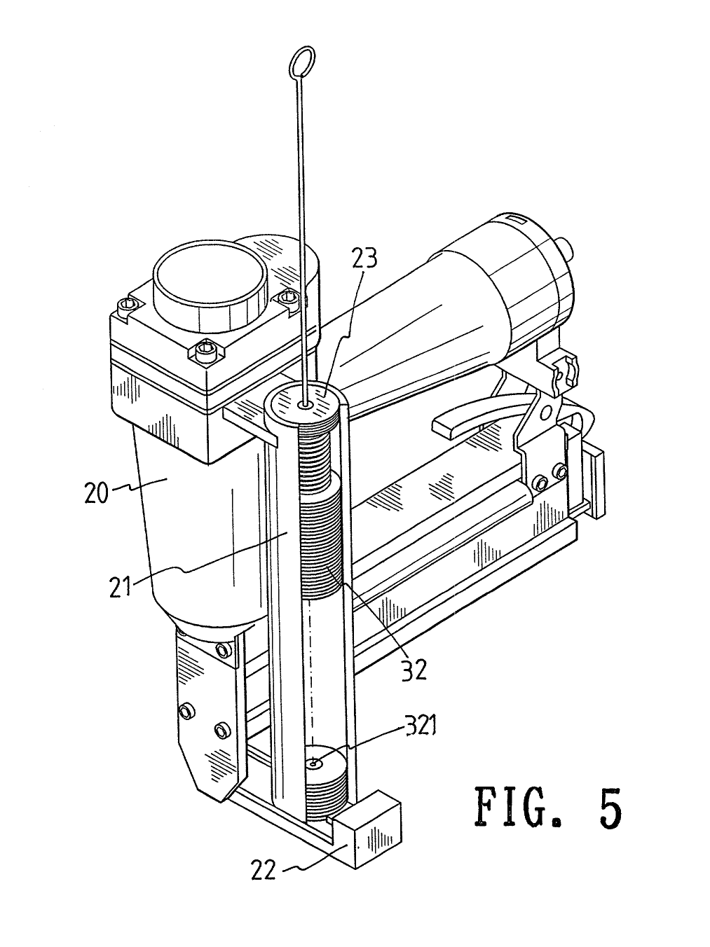

Referring to FIGS. 3 to 5, the washer supply device for power nailers of the present invention comprises a hollow tubular member 21 which is connected to a side of a power nailer 20 and an elongated opening 213 is defined longitudinally through the tubular member 21. A washer transferring member 22 is connected to a nose portion of the power nailer 20 and a lower end of the tubular member 21 is rested on the washer transferring member 22. A hole 221 is defined through the washer transferring member 22 and communicates with an interior of the tubular member 21. A cap 210 is threadedly connected to a top end of the tubular member 21 and a pushing rod 211 extends through the cap 210. A pushing end 212 is connected to a lower end of the pushing rod 211 and a spring 23 mounted to the pushing rod 211 is located between the cap 210 and the pushing end 212.

A pile of washers 32 each have a central hole 321 and a flexible wire 31 frictionally extends through the central holes 321 so that the washers 32 are collected as a pile by the friction of the wire 31. The washers 32 are then received in the tubular member 21 via the opening 213, and the wire 31 is pulled out from the washers 32 via the hole 221 in the washer transferring member 22. The pile of washers 32 are pressed by the pushing end 212 and the lowest washer 32 will be sent in the washer transferring member 22.

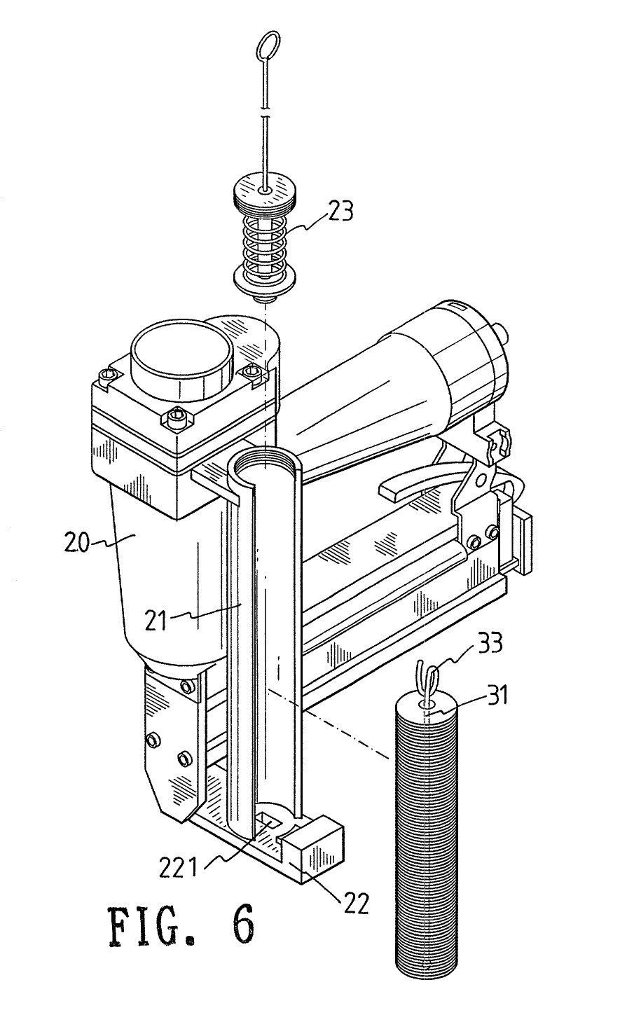

FIG. 6 shows that the top end 33 of the wire 31 can be made to be a large head which applies a force to the pile of the washers 31 so that the pile washers 32 are conveniently collected together and carried.

While we have shown and described various embodiments in accordance with the present invention, it should be clear to those skilled in the art that further embodiments may be made without departing from the scope and spirit of the present invention.

What is claimed is:

1. A washer supply device comprising:
a hollow tubular member adapted to be connected to a side of a power nailer and an opening defined longitudinally through said tubular member, a washer transferring member adapted to be connected to the power nailer and a lower end of said tubular member rested on said washer transferring member, a hole defined through said washer transferring member and communicating with an interior of said tubular member;
a cap connected to a top end of said tubular member and a pushing rod extending through said cap and a pushing end connected to a lower end of said pushing rod, a spring mounted to said pushing rod and located between said cap and said pushing end, and
a plurality of washers each having a central hole and a flexible wire frictionally extending through said central holes, said washers received in said tubular member via said opening, said wire being pulled out from said washers via said hole in said washer transferring member.
